(19) United States
(12) Patent Application Publication
(10) Pub. No.: US 2026/0007989 A1
(43) Pub. Date: Jan. 8, 2026

(54) FILTER ELEMENT AND FILTER SYSTEM

(71) Applicant: MANN+HUMMEL GmbH, Ludwigsburg (DE)

(72) Inventors: Christian THALMANN, Speyer (DE); Tomás VALOUSEK, Syrovice (CZ); Mike MÄRTZ, Harthausen (DE)

(21) Appl. No.: 19/246,945

(22) Filed: Jun. 24, 2025

(30) Foreign Application Priority Data
Jul. 8, 2024 (DE) 102024119374.3

(51) Int. Cl. B01D 35/30; B01D 29/11

(52) U.S. Cl. CPC B01D 35/30; B01D 29/114; B01D 2201/291; B01D 2201/304; B01D 2201/305; B01D 2201/4015; B01D 2201/4061

(57) ABSTRACT

A filter element for a fluid to be installed in a housing of a filter system, wherein the housing has at least a first housing part, a second housing part, and a filter head, is provided with a filter medium body having an end disc at an end face. One or more connection elements for connecting the filter element to at least one counterpart connection element of the second housing part are arranged at the end disc and extend away from the end disc in a longitudinal direction of the filter element. A filter system is provided with such a filter element which is arranged in the housing of the filter system and is connected to the counterpart connection element of the second housing part.

### CROSS-REFERENCE TO RELATED APPLICATION

This application claims the benefit of German Application No. 10 2024 119 374.3 filed on Jul. 8, 2024, the entire contents of which is incorporated herein by reference.

### BACKGROUND

The invention concerns a filter element for a fluid, for example for a liquid, for example oil or fuel, and a filter system for a fluid, for example for a liquid, for example oil or fuel.

Filter systems for fluids, for example for liquids, for example oil or fuel, in which snap-fit connections for mounting the individual components are used, are known.

WO 2023/132238 A1 discloses a filter system in which a fluid container, which includes a fluid inlet and a fluid outlet, is connected to a flange of a filter housing by snap hooks.

US 2017/0197160 A1 describes a filter system with a closure element which blocks a fluid outlet when the filter element is removed from the filter housing. The closure element is clipped onto a connection socket.

### SUMMARY

It is an object of the invention to provide a filter element for a fluid, for example for a liquid, for example oil or fuel, with which a simple and safe removal from the filter housing is possible.

A further object of the invention is to provide a filter system for a fluid, for example for a liquid, for example oil or fuel, including such a filter element.

The aforementioned object is solved according to an aspect of the invention by a filter element for a fluid, for example for a liquid, for example oil or fuel, for installation in a housing of a filter system provided with at least a first housing part, a second housing part, and a filter head, the filter element at least including a filter medium body, which includes a first end disc at least at a first end face, and at least a connection element for connecting the filter element to at least one counterpart connection element of the second housing part, wherein the at least one connection element is arranged at the first end disc and extends away from the first end disc in a longitudinal direction.

The further object is solved according to a further aspect of the invention by a filter system for a fluid, for example for a liquid, for example oil or fuel, including a housing with a fluid inlet and a fluid outlet and further including a filter element arranged in the housing, wherein the housing includes at least a first housing part, a second housing part, and a filter head, wherein the first housing part is connected to the filter head and wherein the second housing part is arranged, suspended from a recess, in the filter head, wherein the filter element includes a filter medium body, which includes a first end disc at least at a first end face, and at least one connection element for connecting the filter element to a counterpart connection element of the second housing part.

Beneficial embodiments and advantages of the invention result from the following description and the accompanying drawings.

According to an aspect of the invention, a filter element for a fluid, for example for a liquid, for example oil or fuel, for installation in a housing of a filter system provided with at least a first housing part, a second housing part, and a filter head is proposed, the filter element including at least a filter medium body, which includes a first end disc at least at a first end face, and at least one connection element for connecting the filter element to at least one counterpart connection element of the second housing part. In this context, the at least one connection element is arranged at the first end disc and extends away from the first end disc in a longitudinal direction.

The housing of the filter system includes the filter head, a first housing part, and a second housing part. The first housing part is screwed into the filter head and sealed. The second housing part is suspended from a recess of the filter head. The housing may be opened via the first housing part.

A first, lower, end disc of the filter element may be seal-tightly connected to a fluid outlet of the second housing part. The fluid outlet of the second housing part leads directly into a fluid tank.

In this manner, the filter element may be securely connected by at least one connection element and a counterpart connection element to the second housing part of the filter system. The connection element may be arranged, for example, at the first end disc while the counterpart connection element may be arranged at an outlet socket of the second housing part. The filtered fluid may thus flow through a central opening of the end disc directly into the outlet socket of the fluid outlet of the second housing part.

The filter element may be for example configured as a hollow-cylindrical round filter which may be flowed through from a radially outer side to an inner side by the fluid.

Also, other geometric shapes of a filter element may be used.

When exchanging the filter element, the second housing part may be removed together with the filter element from the filter head. In this context, raw fluid possibly remaining between the filter element and the housing wall is retained in the second housing part. Subsequently, the filter element may be removed from the second housing part by releasing the connection element and counterpart connection element.

Servicing of the filter system may be performed more easily in this manner. The raw fluid retained in the second housing part at the outer side of the filter medium body does not reach the fluid tank when the filter element is exchanged.

According to a beneficial embodiment of the filter element, the first end disc may include at least a central fluid opening which opens in longitudinal direction for flow of the fluid therethrough. In this way, the filtered fluid may flow simply through the fluid outlet into the fluid tank.

According to an embodiment of the filter element, the at least one connection element may be configured as a component of a snap-fit connection. By means of a snap-fit connection, the filter element may be securely connected to the second housing part and may also be released again in a non-destructive manner.

According to an embodiment of the filter element, the at least one connection element may include a radially outwardly oriented snap hook extending in longitudinal direction as a connection element. In this manner, the filter element may be locked securely at the second housing part and may also be released again.

According to an embodiment of the filter element, the at least one connection element may be designed as a part of a bayonet connection. By means of such a bayonet connection, a simple and secure connection of the filter element to the second housing part may be produced, and also which may be easily released again after removal of filter element and second housing part from the filter head.

According to an embodiment of the filter element, the at least one connection element may be configured as one piece together with the first end disc. In this manner, the connection element may be integrated beneficially into the first end disc. The manufacture of the filter element may be simplified in this way.

According to an embodiment of the filter element, the first end disc may include guide elements extending in longitudinal direction. In particular, in this context two guide elements may enclose between them one connection element, respectively. The guide elements may facilitate insertion of the filter element into the second housing part. In addition, the connection elements are protected in this way when handling the filter element.

According to an embodiment of the filter element, the first end disc may include a collar extending in longitudinal direction away from the first end disc, wherein the at least one connection element is arranged at the collar. In this context the collar may include a radially outwardly positioned, circumferentially extending seal element. In this manner, the filter element may be locked securely at the second housing part and may also be released again. In addition, a reliable sealing action between filter element interior and outlet socket may be ensured.

According to a further aspect of the invention, a filter system for a fluid, for example for a liquid, for example oil or fuel, is proposed, including a housing with a fluid inlet and a fluid outlet and a filter element arranged in the housing, wherein the housing includes at least a first housing part, a second housing part, and a filter head, wherein the first housing part is connected to the filter head and wherein the second housing part is arranged, suspended from a recess, in the filter head. In this context, the filter element includes a filter medium body, which includes a first end disc at least at a first end face, and at least at one connection element for connecting the filter element to a counterpart connection element of the second housing part.

The housing of the filter system includes the filter head, a first housing part, and a second housing part with a filter element contained therein. The first housing part is screwed into the filter head and sealed. The second housing part is suspended from a recess of the filter head. The housing may be opened via the first housing part.

A first, lower, end disc of the filter element is seal-tightly connected to a fluid outlet of the second housing part. The fluid outlet of the second housing part leads directly into a fluid tank.

The filter element in this context is securely connected by at least one connection element and a counterpart connection element to the second housing part. The connection element may be arranged, for example, at the first end disc while the counterpart connection element is arranged at an outlet socket of the second housing part. The filtered fluid may thus flow through a central opening of the end disc directly into the outlet socket of the fluid outlet.

The filter element may be configured for example as a hollow-cylindrical round filter which is flowed through from a radially outer side to an inner side by the fluid.

Also, other geometric shapes of a filter element may be used.

When exchanging the filter element, the second housing part may be removed together with the filter element from the filter head. In this context, raw fluid possibly remaining between filter element and housing wall is retained in the second housing part. Subsequently, the filter element may be removed from the second housing part by releasing the connection element and counterpart connection element.

Servicing of the filter system may be performed more easily in this manner. The raw fluid retained in the second housing part at the outer side of the filter medium body does not reach the fluid tank when the filter element is exchanged.

According to an embodiment of the filter system, the at least one connection element and the at least one counterpart connection element may be configured as a component of a snap-fit connection. By means of the snap-fit connection, the filter element may be securely connected to the second housing part and may also be released again in a non-destructive manner.

According to an embodiment of the filter system, the at least one connection element may include a radially outwardly oriented snap hook extending in longitudinal direction and the counterpart connection element of the second housing part may be designed as a radially inwardly oriented, circumferentially extending projection. As an alternative, the at least one connection element may be configured as a radially inwardly oriented, circumferentially extending projection and the at least one counterpart connection element of the second housing part may include a radially outwardly oriented snap hook extending in longitudinal direction. In this manner, the filter element may be locked securely at the second housing part and may also be released again.

According to an embodiment of the filter system, the at least one connection element and the at least one counterpart connection element may be configured as a component of a bayonet connection. By means of such a bayonet connection, a simple and secure connection of the filter element to the second housing part may be produced, and also which may be released again easily after removal of the filter element and of the second housing part from the filter head.

According to an embodiment of the filter system, the first end disc of the filter element may include a collar which is extending in longitudinal direction away from the first end disc, wherein the at least one connection element is arranged at the collar. In this context, the second housing part may include an outlet socket extending in longitudinal direction into an interior of the second housing part, wherein the counterpart connection element is arranged at the outlet socket and the outlet socket is configured for accommodating the collar when the filter element is mounted as intended in the second housing part. In this context, the collar may include a radially outwardly positioned, circumferentially extending seal element. In this manner, the filter element may be locked securely at the second housing part and may also be released again. In addition, a reliable sealing action between filter element interior and outlet socket may be ensured.

### BRIEF DESCRIPTION OF DRAWINGS

Further advantages result from the following drawings description. In the drawings, embodiments of the invention are illustrated. The drawings and the descriptions contain numerous features in combination. A person of skill in the art will expediently consider the features also individually and combine them to expedient further combinations.

FIG. 1 shows an isometric illustration of a filter system for a fluid, for example for a liquid, for example oil or fuel, with a filter element according to an embodiment of the invention.

FIG. 2 shows an exploded illustration of the filter system according to FIG. 1.

FIG. 3 shows an exploded illustration of the filter system mounted at a tank cover of a fluid tank.

FIG. 4 shows a longitudinal section through the filter system according to FIG. 1.

FIG. 5 shows a detail B of the filter system according to FIG. 4.

FIG. 6 shows an isometric view of a first end face of the filter element.

### DETAILED DESCRIPTION

In the drawing figures, same or same-type components are identified with same reference characters. The drawing figures show only examples and are not to be understood as limiting.

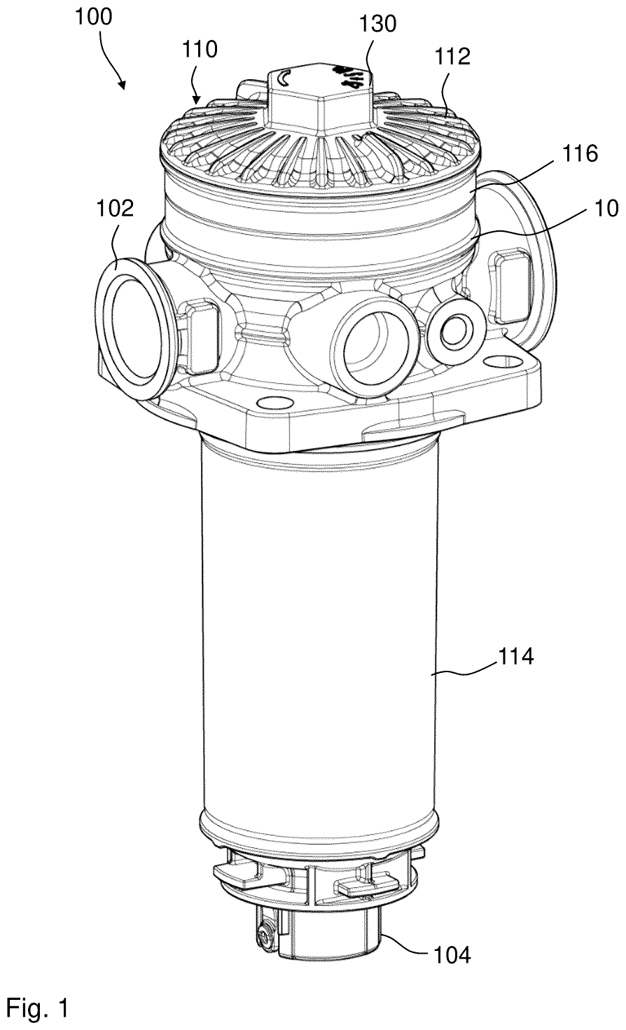

For explaining the invention, FIG. 1 shows an isometric illustration of a filter system 100 for a fluid, for example for a liquid, for example oil or fuel, comprising a filter element 10 according to an embodiment of the invention.

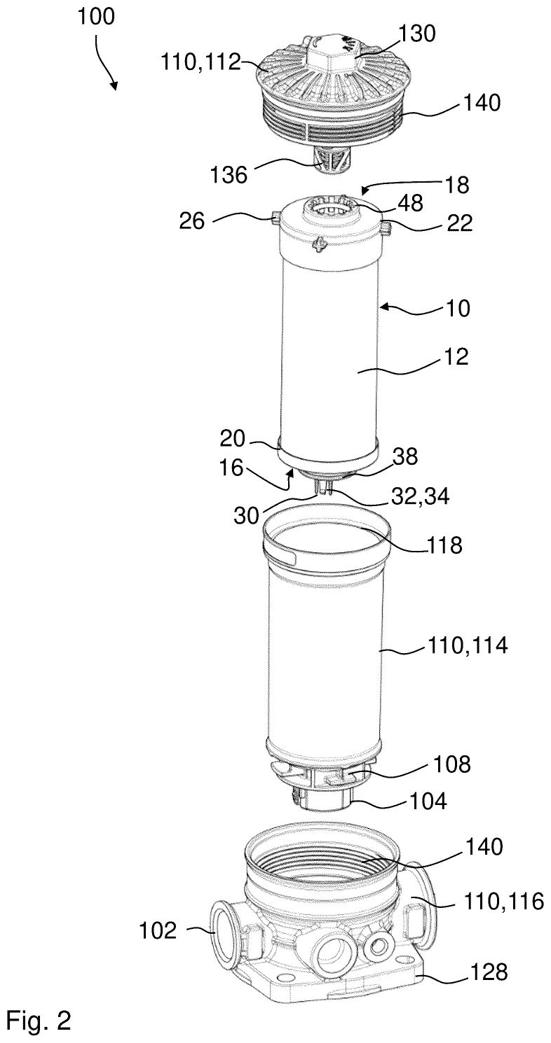

FIG. 2 shows an exploded illustration of the filter system 100 according to FIG. 1.

The filter system 100 comprises a housing 110 with a fluid inlet 102 and a fluid outlet 104 and a filter element 10 arranged in the housing 110.

The housing 110 comprises a first housing part 112, a second housing part 114, and a filter head 116. The first housing part 112 is connected to the filter head 116, for example by a screw thread 140. The second housing part 114 extends through the filter head 116 and is seal-tightly connected thereto. For this purpose, the second housing part 114 is arranged, suspended from a recess 118, in the filter head 116.

The first housing part 112 comprises a tool engagement part 130 in the form of a hexagon for easier opening of the housing 110 by turning the first housing part 112 in relation to the filter head 116.

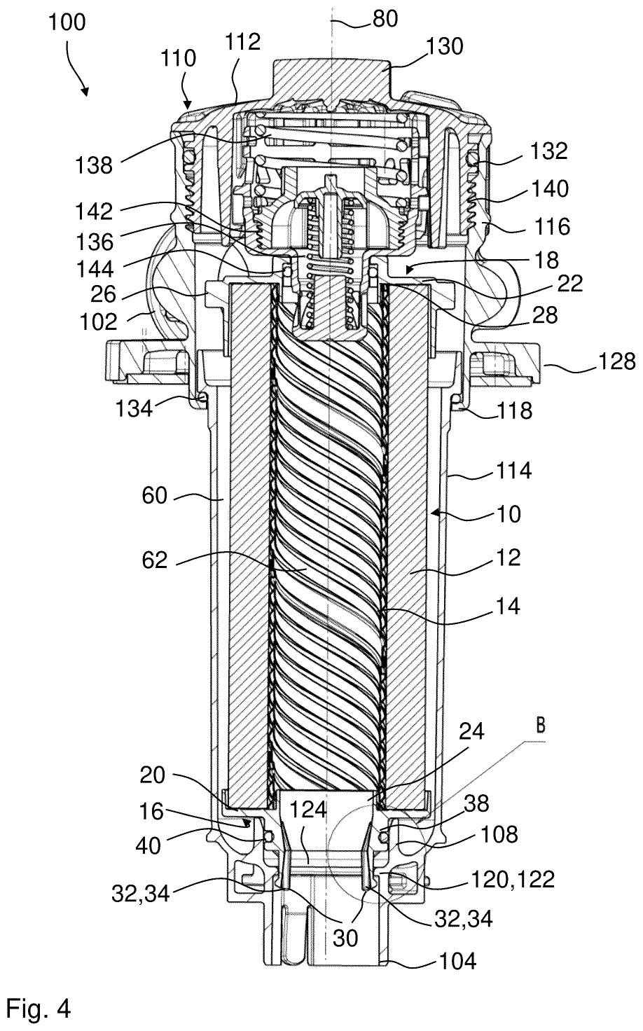

A hollow-cylindrical filter element 10 is arranged in the second housing part 114. The filter element 10 comprises a filter medium body 12, which comprises a first end disc 20 at least at a first end face 16, and two connection elements 32 for connecting the filter element 10 to a counterpart connection element 120 of the second housing part 114 (see FIG. 4).

As seen in FIG. 2, the filter element 10 comprises at its second end disc 22 radially outwardly projecting mounting elements 26 for mounting in the second housing part 114 in a mixup-proof manner.

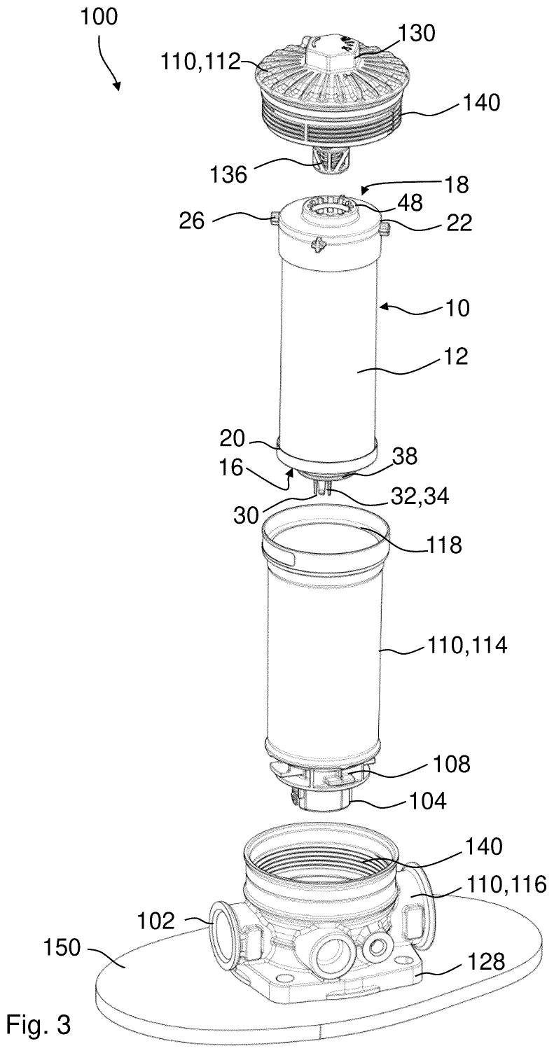

In FIG. 3, an exploded illustration of the filter system 100 is illustrated with the filter head 116 mounted at a tank cover 150 or an outer wall of a fluid tank.

When the filter system 100 is mounted at a fluid tank, the second housing part 114 projects through the filter head 116 into the interior of the fluid tank. The filtered fluid may thus flow simply into the fluid tank. The filter head 116 is mounted with its mounting device 128 at the tank cover 150. In an alternative embodiment, not illustrated, the filter head 116 is mounted with its mounting device 128 at an outer wall of the fluid tank.

FIG. 4 shows a longitudinal section through the filter system 100 according to FIG. 1 with inserted filter element 10.

The filter element 10 comprises the hollow-cylindrical filter medium body 12 which is flowed through radially from the exterior (outer) to the interior (inner) by the fluid. The filter medium body 12 is supported at its inner side by a support pipe 14 against the hydraulic pressure of the flowing fluid. In the embodiment, the support pipe 14 is designed in a spiral shape with passages.

The filter element 10 comprises a first end disc 20 at a first end face 16 and a second end disc 22 at a second end face 18.

The first end disc 20 comprises a central fluid opening 24 in longitudinal direction 80 for flow of the filtered fluid therethrough.

At the first end disc 20, two connection elements 32 are arranged for connecting the filter element 10 to the counterpart connection element 120 of the second housing part 114. The two connection elements 32 extend away from the first end disc 20 in a longitudinal direction 80. The connection elements 32 are configured as one piece together with the first end disc 20.

The second housing part 114 comprises an outlet socket 108 extending in longitudinal direction 80 into an interior 124 of the second housing part 114. In this context, the counterpart connection element 120 is arranged at the outlet socket 108 and the outlet socket 108 is configured for accommodating the collar 38 when the filter element 10 is mounted as intended in the second housing part 114.

The first end disc 20 of the filter element 10 comprises a collar 38 extending in longitudinal direction 80 away from the first end disc 20. In this context, the connection elements 32 are arranged at the collar 38. The collar 38 comprises a radially outwardly positioned, circumferentially extending seal element 40, for example, an O-ring, for sealing in relation to the outlet socket 108.

The connection elements 32 are configured as components of a snap-fit connection 30 and comprise radially outwardly oriented snap hooks 34 extending in longitudinal direction 80. The counterpart connection element 120, which is arranged at the outlet socket 108 of the second housing part 114 and is configured as a radially inwardly oriented, circumferentially extending projection 122, forms the other component of the snap-fit connection 30.

As an alternative, the at least one connection element 32 could also be configured as a radially inwardly oriented, circumferentially extending projection 122 and the at least one counterpart connection element 120 of the second housing part 114 could comprise at least one radially outwardly oriented snap hook 34 extending in longitudinal direction 80.

In a further embodiment, not illustrated, the at least one connection element 32 and the at least one counterpart connection element 120 could also be configured as components of a bayonet connection.

The second housing part 114 with the filter element 10 arranged therein is arranged at the recess 118 of the filter head 116 in a suspended manner. In this context, a circumferentially extending seal element 134, for example, an O-ring, is inserted for sealing between an inner wall of the filter head 116 and the second housing part 114.

The first housing part 112 is connected by means of the screw thread 140 to the filter head 116 wherein a circumferentially extending seal element 132, for example, an O-ring, is arranged between filter head 116 and first housing part 112 for sealing purposes.

The second end disc 22 comprises a central opening 28 for accommodating a pressure relief valve 136. The pressure relief valve 136 comprises two parts which are screwed together by a screw thread 142. The pressure relief valve 136 is pushed into the central opening 28 of the second end disc 22 and is sealed by means of a circumferentially extending seal element 144, for example, an O-ring, in relation to the end disc 22. The pressure relief valve 136 is pretensioned by means of a spring element 138 upon screwing the first housing part 112 onto the filter head 116 so that it is arranged securely in the opening 28 of the second end disc 22.

During servicing, when the housing 110 is opened via the first housing part 112, the filter element 10 may be removed. In doing so, the second housing part 114 is pulled out of the filter head 116 together with the filter element 10 since the filter element 10 is locked at the second housing part 114. In this context, raw fluid still contained between the second housing part 114 and the filter element 10 remains in the second housing part 114. When both parts are pulled out, the filter element 10 may be released from the second housing part 114 and the residual raw fluid may be disposed of. A new filter element 10 may be inserted into the second housing part 114 and inserted again into the filter head 116 together with the second housing part 114.

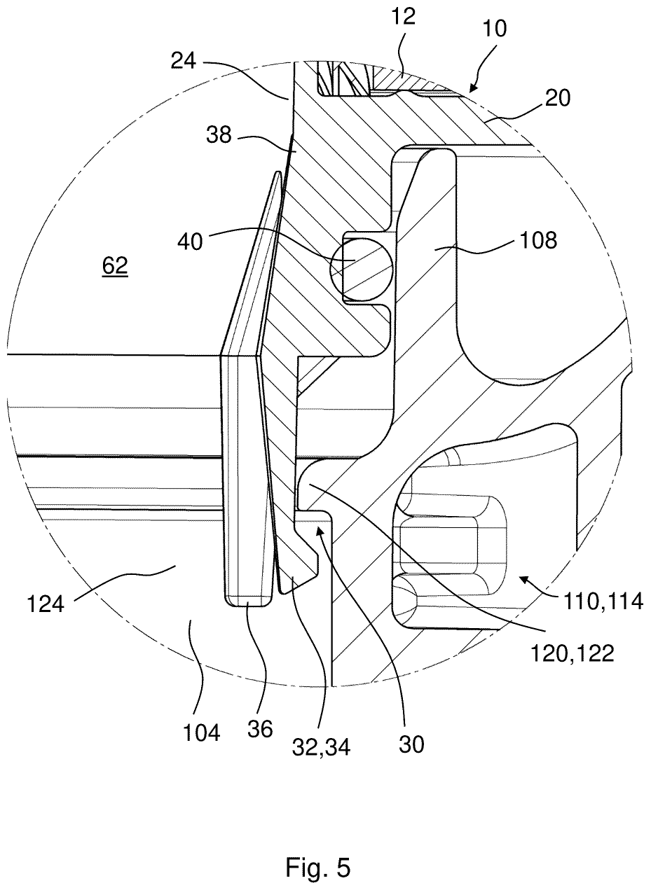

In FIG. 5, a detail B of the filter system 100 according to FIG. 4 is illustrated.

Here, a part of the first end disc 20 of the filter element 10 provided with the collar 38 extending away from the first end disc 20 in the longitudinal direction 80 may be seen at which a connection element 32 is arranged which is configured as a snap-fit element 34. The snap-fit element 34 is locked at the projection 122 of the counterpart connection element 120 which is a component of the outlet socket 108. The seal element 40 is arranged between collar 38 and the outlet socket 108 and ensures sealing between the filter element 10 and the second housing part 114 so that clean fluid region 62 and raw fluid region 60 are separated.

A guide element 36 may be seen adjacent to the snap-fit element 34.

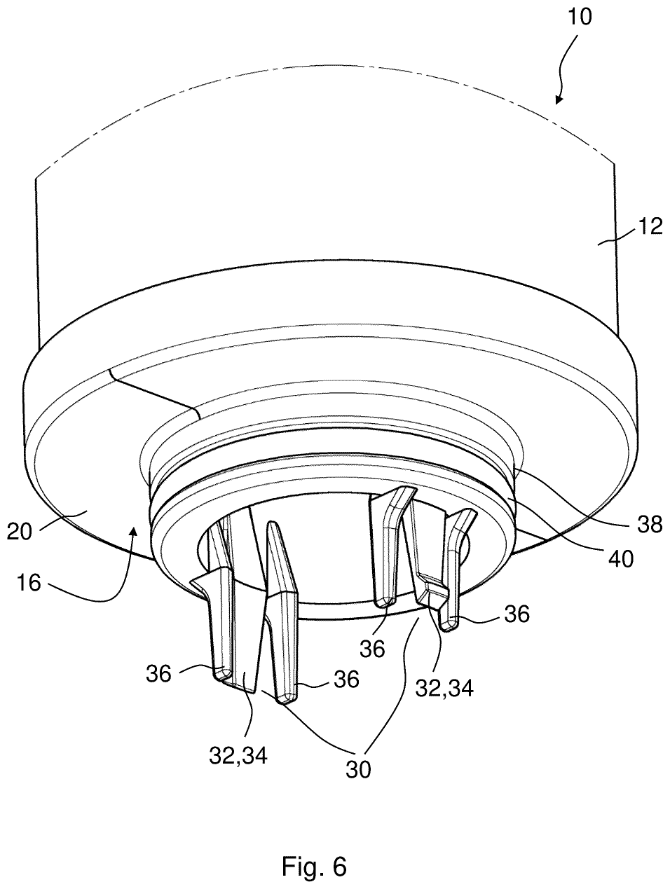

FIG. 6 shows an isometric view of a first end face 16 of the filter element 10.

The filter medium body 12 of the filter element 10 is closed off at the first end face 16 by the first end disc 20. The first end disc 20 comprises the collar 38 which is projecting away from the first end disc 20 in the longitudinal direction 80. At an inner side of the collar 38, two radially opposed connection elements 32 are arranged which are configured as radially outwardly oriented snap-fit elements 34 in the form of snap hooks.

Furthermore, the first end disc 20 comprises guide elements 36 extending in longitudinal direction 80. In this context, two guide elements 36 enclose between them one connection element 32, respectively. The guide elements 36 may facilitate insertion of the filter element 10 into the second housing part 114. In addition, the connection elements 32 are protected in this way when handling the filter element 10.

The collar 38 comprises a radially outwardly positioned, circumferentially extending seal element 40, for example, an O-ring, for sealing in relation to the outlet socket 108 of the second housing part 114.

### REFERENCE CHARACTERS

10 filter element
12 filter medium body
14 support pipe
16 first end face
18 second end face
20 first end disc
22 second end disc
24 fluid opening
26 mounting element
28 central opening
30 snap-fit connection
32 connection element
34 snap-fit element
36 guide element
38 collar
40 seal element
60 raw fluid region
62 clean fluid region
80 longitudinal direction
100 filter system
102 fluid inlet
104 fluid outlet
108 outlet socket
110 housing
112 first housing part
114 second housing part
116 filter head
118 recess
120 counterpart connection element
122 projection
124 interior
128 mounting device
130 tool engagement part
132 seal element
134 seal element
136 pressure relief valve
138 spring element
140 screw thread
142 screw thread
144 seal element
150 tank cover

What is claimed is:

1. A filter element for a fluid configured to be installed in a housing of a filter system, the housing comprising at least a first housing part, a second housing part, and a filter head; the filter element comprising:
a filter medium body comprising an end disc at an end face;
one or more connection elements configured to connect the filter element to at least one counterpart connection element of the second housing part;
wherein the one or more connection elements are arranged at the end disc and extend away from the end disc in a longitudinal direction of the filter element.

2. The filter element according to claim 1, wherein the end disc comprises at least one central fluid opening which opens in the longitudinal direction for a flow of the fluid therethrough.

3. The filter element according to claim 1, wherein the one or more connection elements are a component of a snap-fit connection.

4. The filter element according to claim 3, wherein the one or more connection elements each comprise a radially outwardly oriented snap hook extending in the longitudinal direction.

5. The filter element according to claim 1, wherein the one or more connection elements are a component of a bayonet connection.

6. The filter element according to claim 1, wherein the one or more connection elements and the end disc together form one piece.

7. The filter element according to claim 1, wherein the end disc comprises guide elements extending in the longitudinal direction.

8. The filter element according to claim 7, wherein the guide elements are arranged such that two of the guide elements enclose therebetween one of the one or more connection elements.

9. The filter element according to claim 1, wherein the end disc comprises a collar extending in the longitudinal direction away from the end disc, wherein the one or more connection elements are arranged at the collar.

10. The filter element according to claim 9, wherein the collar comprises a radially outwardly positioned, circumferentially extending seal element.

11. A filter system for a fluid, the filter system comprising:
a housing comprising a fluid inlet and a fluid outlet;
the housing further comprising a first housing part, a second housing part, and a filter head;
a filter element arranged in the housing;
the filter element comprising a filter medium body comprising an end disc at an end face;
the filter element further comprising one or more connection elements configured to connect the filter element to at least one counterpart connection element of the second housing part;
wherein the one or more connection elements are arranged at the end disc and extend away from the end disc in a longitudinal direction of the filter element.

12. The filter system according to claim 11, wherein the one or more connection elements and the at least one counterpart connection element are components of a snap-fit connection.

13. The filter system according to claim 12, wherein the one or more connection elements each comprise a radially outwardly oriented snap hook extending in the longitudinal direction and wherein the at least one counterpart connection element is a radially inwardly oriented, circumferentially extending projection.

14. The filter system according to claim 11, wherein the one or more connection elements and the at least one counterpart connection element are components of a bayonet connection.

15. The filter system according to claim 11, wherein the end disc of the filter element comprises a collar extending away from the end disc in the longitudinal direction, wherein the one or more connection elements are arranged at the collar.

16. The filter system according to claim 15, wherein the second housing part comprises an outlet socket extending in the longitudinal direction, wherein the at least one counterpart connection element is arranged at the outlet socket, wherein the outlet socket accommodates the collar when the filter element is mounted in the second housing part.

17. The filter system according to claim 16, wherein the collar comprises a radially outwardly positioned, circumferentially extending seal element.

18. A filter system for a fluid, the filter system comprising:
a housing comprising a fluid inlet and a fluid outlet;
the housing further comprising a first housing part, a second housing part, and a filter head;
a filter element arranged in the housing;
the filter element comprising a filter medium body comprising an end disc at an end face;
the filter element further comprising at least one connection element configured to connect the filter element to at least one counterpart connection element of the second housing part;
wherein the at least one connection element is arranged at the end disc;
wherein the at least one connection element is a radially inwardly oriented, circumferentially extending projection; and
wherein the at least one counterpart connection element of the second housing part comprises at least one radially outwardly oriented snap hook extending in the longitudinal direction.
